(19) United States
(12) Patent Application Publication
(10) Pub. No.: US 2025/0006125 A1
(43) Pub. Date: Jan. 2, 2025

(54) PIXEL AND DISPLAY DEVICE INCLUDING THE SAME

(71) Applicant: Samsung Display Co., Ltd., Yongin-Si (KR)

(72) Inventors: Won Jun LEE, Yongin-si (KR); Kwi Hyun KIM, Yongin-si (KR); Yeon Kyung KIM, Yongin-si (KR)

(21) Appl. No.: 18/629,024

(22) Filed: Apr. 8, 2024

(30) Foreign Application Priority Data
Jun. 28, 2023 (KR) 10-2023-0083695

(51) Int. Cl. G09G 3/3233; G09G 3/3266

(52) U.S. Cl. CPC G09G 3/3233; G09G 3/3266; G09G 2300/0819; G09G 2300/0852; G09G 2300/0861; G09G 2310/08; G09G 2330/02

(57) ABSTRACT

A pixel may include: a first transistor including a gate electrode connected to a first node, a first electrode connected to a first power line, and a second electrode connected to a second node, and; a second transistor including a first electrode connected to a data line, a second electrode, and a gate electrode connected to a first scan line; a third transistor connected between the data line and a third node, and including a gate electrode connected to a second scan line; a fourth transistor connected between the second node and the third node, and including a gate electrode connected to an emission control line; a first capacitor connected between the second transistor and the first node; a second capacitor connected between the first power line and the first node, and a light emitting element connected between the third node and a second power line.

### CROSS-REFERENCE TO RELATED APPLICATION

The present application claims priority to Korean patent application number 10-2023-0083695 filed on Jun. 28, 2023, the entire disclosure of which is incorporated herein in its entirety by reference.

### BACKGROUND

### 1. Technical Field

Various embodiments of the present disclosure relate to a pixel and a display device including the pixel.

### 2. Related Art

With the development of information technology, the importance of a display device, which is a connection medium between a user and information, has been emphasized. Owing to the importance of display devices, the use of various kinds of display devices such as a liquid crystal display device and an organic light-emitting display device has increased.

Recently, there has been development in head mounted display devices (HMDs). The head mounted display device (HMDs) are display devices which allow a user to wear in the form of glasses or a helmet, and are used to create virtual reality (VR) or augmented reality (AR) experiences where the focus is formed at a close distance in front of the eyes of the user. Head mounted display devices employ high-resolution panels.

### SUMMARY

Various embodiments of the present disclosure are directed to a pixel, which can be applied to a high-resolution panel, and a display device including the pixel.

An embodiment of the present disclosure may provide a pixel including: a first transistor including a gate electrode connected to a first node, a first electrode electrically connected to a first power line configured to supply first driving power, and a second electrode connected to a second node, and; a second transistor including a first electrode electrically connected to a data line, a second electrode, and a gate electrode electrically connected to a first scan line; a third transistor connected between the data line and a third node, and including a gate electrode electrically connected to a second scan line; a fourth transistor connected between the second node and the third node, and including a gate electrode electrically connected to an emission control line; a first capacitor including a first electrode connected to the second electrode of the second transistor, a second electrode connected to the first node; and a second capacitor connected between the first power line and the first node; and a light emitting element connected between the third node and a second power line configured to supply second driving power.

In an embodiment, the pixel may further include a fifth transistor connected between the first node and the second node, and including a gate electrode electrically connected to a third scan line.

In an embodiment, the pixel may further include a sixth transistor connected between the first node and the third node, and including a gate electrode electrically connected to the second scan line.

In an embodiment, during at least a partial period of a first period of a horizontal period in which a data signal is supplied to the pixel, the second to the sixth transistors may be set to a turn-on state. During the first period, a voltage of reference power having a voltage value between the first diving power and the second driving power may be supplied to the data line.

In an embodiment, during the first period, the third transistor, the fifth transistor, and the sixth transistor may be set to a turn-off state at least one time.

In an embodiment, during a second period following the first period in the horizontal period, the second transistor and the fifth transistor may be set to the turn-on state. During the second period, the voltage of the reference power may be supplied to the data line.

In an embodiment, during a third period following the second period in the horizontal period, the second transistor may be set to the turn-on state. During the third period, a voltage of the data signal may be supplied to the data line.

In an embodiment, the pixel may further include a sixth transistor connected between the first node and the third node, and including a gate electrode electrically connected to the second scan line.

In an embodiment, the third scan line may be a scan line identical to the second scan line.

In an embodiment, during at least a partial period of a first period of a horizontal period in which a data signal is supplied to the pixel, the second to the sixth transistors may be set to the turn-on state. During the first period, the voltage of the reference power having a voltage value between the first diving power and the second driving power may be supplied to the data line.

In an embodiment, during the first period, the third transistor, the fifth transistor, and the sixth transistor may be set to a turn-off state at least one time.

In an embodiment, during the second period following the first period in the horizontal period, the second transistor, the third transistor, the fifth transistor, and the sixth transistor may be set to the turn-on state. During the second period, the voltage of the reference power may be supplied to the data line.

In an embodiment, during a third period following the second period in the horizontal period, the second transistor may be set to the turn-on state. During the third period, the voltage of the data signal may be supplied to the data line.

An embodiment of the present disclosure may provide a display device, including pixels connected to first scan lines, second scan lines, third scan lines, data lines, and emission control lines. A pixel disposed in an i-th pixel row (i is an integer of 0 or more) and a j-th pixel column (j is an integer of 0 or more) may include: a first transistor including a gate electrode connected to a first node, a first electrode electrically connected to a first power line configured to supply first driving power, and a second electrode connected to a second node; a second transistor including a first electrode electrically connected to a j-th data line and a second electrode, and configured to be turned on in response to a first scan signal supplied from an i-th first scan line; a third transistor connected between the j-th data line and a third node, and configured to be turned on in response to a second scan signal supplied from an i-th second scan line; a fourth transistor connected between the second node and the third node, and configured to be turned off in response to an emission control signal supplied from a k-th emission control line (where k is an integer of 0 or more); a first capacitor including a first electrode connected to the second electrode of the second transistor and the first node; a second capacitor connected between the first power line and the first node; and a light emitting element connected between the third node and a second power line configured to supply second driving power.

In an embodiment, the pixel disposed in the i-th pixel row and the j-th pixel column may further include: a fifth transistor connected between the first node and the second node, and configured to be turned on in response to a third scan signal supplied from an i-th third scan line; and a sixth transistor connected between the first node and the third node, and configured to be turned on in response to the second scan signal supplied from the i-th second scan line.

In an embodiment, a horizontal period in which a data signal is supplied the pixel disposed in the i-th pixel row and the j-th pixel column may include a first period, a second period, and a third period. The display device may further include: a data driver configured to supply a voltage of reference power having a voltage value between the first driving power and the second driving power to the j-th data line during the first period and the second period, and supply the data signal to the j-th data line during the third period; a first scan driver configured to supply the first scan signal to the i-th first scan line during the first to the third periods; a second scan driver configured to supply the second scan signal to the i-th second scan line during the first period; a third scan driver configured to supply the third scan signal to the i-th third scan line during the first period and the second period; and an emission driver configured to supply the emission control signal to the k-th emission control line during the second period and the third period.

In an embodiment, the second scan driver may supply a gate-off voltage to the i-th second scan line at least one time during the first period. The third scan driver may supply a gate-off voltage to the i-th third scan line at least one time during the first period.

In an embodiment, the pixel disposed in the i-th pixel row and the j-th pixel column may further include: a fifth transistor connected between the first node and the second node, and configured to be turned on in response a third scan signal supplied from an i-th third scan line; and a sixth transistor connected between the first electrode of the first capacitor and the third node, and configured to be turned on in response to the second scan signal supplied from the i-th second scan line.

In an embodiment, a horizontal period in which a data signal is supplied the pixel disposed in the i-th pixel row and the j-th pixel column may include a first period, a second period, and a third period. The display device may further include: a data driver configured to supply a voltage of reference power having a voltage value between the first driver power and the second driving power to the j-th data line during the first period and the second period, and supply the data signal to the j-th data line during the third period; a first scan driver configured to supply the first scan signal to the i-th first scan line during the first to the third periods; a second scan driver configured to supply the second scan signal to the i-th second scan line during the first period and the second period; a third scan driver configured to supply the third scan signal to the i-th third scan line during the first period and the second period; and an emission driver configured to supply the emission control signal to the k-th emission control line during the second period and the third period.

In an embodiment, the i-th second scan line may be a scan line identical to the i-th third scan line. The second scan driver is a scan driver identical to the third scan driver.

The objects of the present disclosure are not limited to the above-stated object, and those skilled in the art will clearly understand other not mentioned objects from the accompanying claims.

### BRIEF DESCRIPTION OF THE DRAWINGS

FIG. 1 is a diagram illustrating a display device in accordance with an embodiment of the present disclosure.

FIG. 2 is a diagram illustrating an embodiment of a scan driver and an emission driver that are illustrated in FIG. 1.

FIG. 3 is a diagram illustrating a pixel in accordance with an embodiment of the present

disclosure.

FIG. 4 is a waveform diagram illustrating an embodiment of a method of driving the pixel shown in FIG. 3.

FIGS. 5A, 5B, 5C and 5D are diagrams illustrating an embodiment of a process of operating the pixel corresponding to the driving waveform in FIG. 4.

FIG. 6 is a diagram illustrating a current error of the pixel shown in FIG. 3.

FIG. 7 is a diagram illustrating an embodiment of a method of driving the pixel shown in FIG. 3.

FIG. 8 is a diagram illustrating a pixel in accordance with an embodiment of the present disclosure.

FIG. 9 is a diagram illustrating an embodiment of a method of driving the pixel shown in FIG. 8.

FIGS. 10A, 10B, 10C and 10D are diagrams illustrating an embodiment of a process of operating the pixel corresponding to the driving waveform in FIG. 9.

FIG. 11 is a diagram illustrating a current error of the pixel shown in FIG. 8.

FIG. 12 is a diagram illustrating a pixel in accordance with an embodiment of the present disclosure.

FIG. 13 is a diagram illustrating an embodiment of a method of driving the pixel shown in FIG. 8.

### DETAILED DESCRIPTION

Hereinafter, embodiments of the present invention will be described in detail with reference to the attached drawings, such that those skilled in the art can easily implement the present invention. The present disclosure may be implemented in various forms, and is not limited to the embodiments to be described herein below.

In the drawings, portions which are not related to the present disclosure will be omitted in order to explain the present disclosure more clearly. Reference should be made to the drawings, in which similar reference numerals are used throughout the different drawings to designate similar components. Therefore, the aforementioned reference numerals may be used in other drawings.

For reference, the size of each component and the thicknesses of lines illustrating the component are arbitrarily represented for the sake of explanation, and the present disclosure is not limited to what is illustrated in the drawings. In the drawings, the thicknesses of the components may be exaggerated to clearly depict multiple layers and areas.

Furthermore, the expression “being the same” may mean “being substantially the same”. In other words, the expression “being the same” may include a range that can be tolerated by those skilled in the art. The other expressions may also be expressions from which the term “substantially” has been omitted.

Some embodiments are described in the accompanying drawings in connection with functional blocks, units and/or modules. Those skilled in the art will understand that such blocks, units, and/or modules are physically implemented by logic circuits, discrete components, microprocessors, hard-wired circuits, memory elements, line connections, and other electronic circuits. This may be formed using semiconductor-based fabrication techniques or other fabrication techniques. For blocks, units, and/or modules implemented by a microprocessor or other similar hardware, they may be programmed and controlled using software to perform various functions discussed herein, and may be optionally driven by firmware and/or software. In addition, each block, unit, and/or module may be implemented by dedicated hardware, or be implemented by a combination of the dedicated hardware which performs some functions and a processor which performs different functions (e.g., one or more programmed microprocessors and related circuits). Furthermore, in some embodiments, blocks, units and/or modules may be physically separated into two or more individual blocks, units and/or modules which interact with each other without departing from the scope of the inventive concept. In some embodiments, blocks, units and/or modules may be physically combined into more complex blocks, units and/or modules without departing from the scope of the inventive concept.

The term “connection” between two components may embrace electrical connection and physical connection, but the present disclosure is not limited thereto. For example, the term “connection” used in description with reference to a circuit diagram may refer to electrical connection, and the term “connection” used in description with reference to a sectional view or a plan view may refer to physical connection.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure.

However, the present disclosure is not limited to the following embodiments and may be modified into various forms. Each embodiment to be described below may be implemented alone, or combined with at least another embodiment to make various combinations of embodiments.

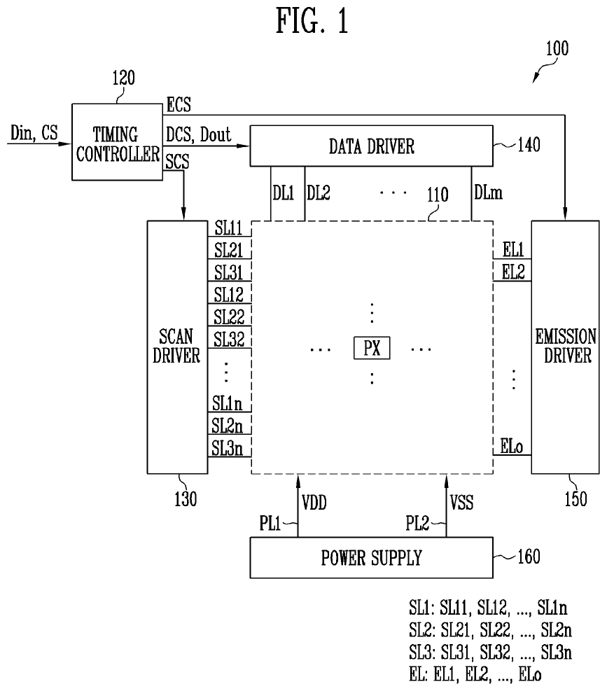

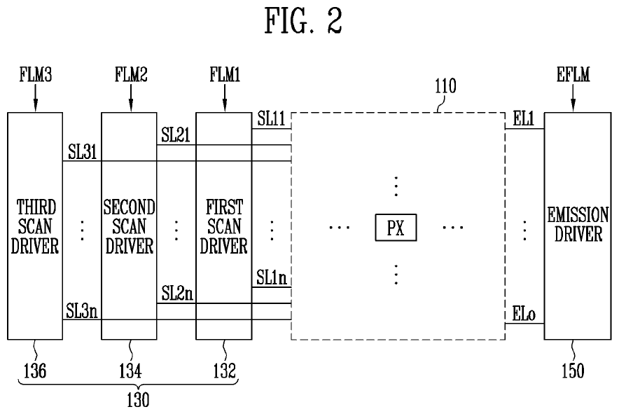

FIG. 1 is a diagram illustrating a display device 100 in accordance with an embodiment of the present disclosure. FIG. 2 is a diagram illustrating an embodiment of a scan driver 130 and an emission driver 150 that are illustrated in FIG. 1.

Referring to FIG. 1, a display device 100 in accordance with an embodiment of the present disclosure may include a pixel component 110 (or a panel), a timing controller 120, the scan driver 130, a data driver 140, the emission driver 150, and a power supply 160. The aforementioned components may be implemented as separate integrated circuits. Two or more components of the aforementioned components may be implemented into a single integrated circuit. Furthermore, the scan driver 130 and the emission driver 150 may be formed in the pixel component 110.

The pixel component 110 may include pixels PX connected to first scan lines SL11, SL12, . . . , and SL1n, second scan lines SL21, SL22, . . . , and SL2n), third scan lines SL31, SL32, . . . , and SL3n, data lines DL1, DL2, . . . , and DLm, emission control lines EL1, EL2, . . . , and ELo, and power lines PL1 and PL2 (where n, m, and o are integers of 0 or more).

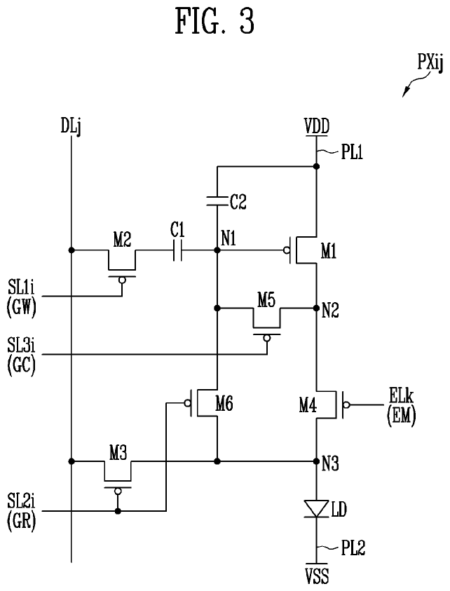

For example, a pixel PXij (refer to FIG. 3) positioned on an i-th horizontal line (or pixel row) and a j-th vertical line (or pixel column) may be connected to an i-th first scan line SL1i, an i-th second scan line SL2i, an i-th third scan line SL3i, a k-th emission control line ELk, and j-th data line DLj (where i is an integer of n or less, j is an integer of m or less, and k is an integer of o or less). Here, k is a number identical to or less than i. For example, in the case where each of the emission control lines EL1 to ELo is connected to pixels PX positioned on one horizontal line, k is a number identical to i. For example, in the case where each of the emission control lines EL1 to ELo is connected to pixels PX positioned on two or more horizontal lines, k is a number less than i.

The pixels PX may be selected on a horizontal line basis (e.g., pixels PX connected to the same scan line may be grouped into one horizontal line (or pixel row)) when a first scan signal is supplied to the first scan lines SL11 to SL1n. Each of the pixels PX that are selected by the first scan signal may receive a data signal from a corresponding data line (any one of DL1 to DLm) connected therewith. The pixels PX that receive data signals may generate certain levels of luminance of light in response to voltages of the data signals.

The scan driver 130 may receive a scan driving control signal SCS from the timing controller 120. The scan driving signal SCS may include at least one scan start signal and clock signals required for driving the scan driver 130. The scan driver 130 may generate a first scan signal, a second scan signal, and a third scan signal while shifting the scan start signal in response to the clock signals.

To achieve the foregoing purpose, as illustrated in FIG. 2, the scan driver 130 may include a first scan driver 132, a second scan driver 134, and a third scan driver 136.

The first scan driver 132 may receive a first scan start signal FLM1 and generate first scan signals while shifting the first scan start signal FLM1 in response to a clock signal. The first scan driver 132 may sequentially supply the first scan signals to the first scan lines SL11 to SL1n.

The second scan driver 134 may receive a second scan start signal FLM2 and generate second scan signals while shifting the second scan start signal FLM2 in response to a clock signal. The second scan driver 134 may sequentially supply the second scan signals to the second scan lines SL21 to SL2n.

The third scan driver 136 may receive a third scan start signal FLM3 and generate third scan signals while shifting the third scan start signal FLM3 in response to a clock signal. The third scan driver 136 may sequentially supply the third scan signals to the third scan lines SL31 to SL3n.

Each of the first scan signals, the second scan signals, and the third scan signals may be set to a gate-on voltage to allow the transistors included in the pixels PX to be turned on.

For example, a first scan signal, a second scan signal, and a third scan signal of a low level may be supplied to a P-type transistor. A first scan signal, a second scan signal, and a third scan signal of a high level may be supplied to an N-type transistor. The transistor supplied with the first scan signal, the second scan signal, or the third scan signal may be turned on in response to the first scan signal, the second scan signal, or the third scan signal.

The supply of the first scan signal, the second scan signal, or the third scan signal may mean that a gate-on voltage is supplied to the first scan line SL1, the second scan line SL2, or the third scan line SL3. No-supply of the first scan signal, the second scan signal, or the third scan signal may mean that a gate-off voltage is supplied to the first scan line SL1, the second scan line SL2, or the third scan line SL3.

Although FIG. 2 illustrates that the first scan driver 132, the second scan driver 134, and the third scan driver 136 are respectively connected with the first scan line SL1, the second scan line SL2, and the third scan line SL3, embodiments of the present disclosure are not limited thereto. For example, at least two scan lines among the first scan line SL1, the second scan line SL2, and the third scan line SL3 (i.e., at least two of SL1, SL2, and SL3) may be driven by a single scan driver.

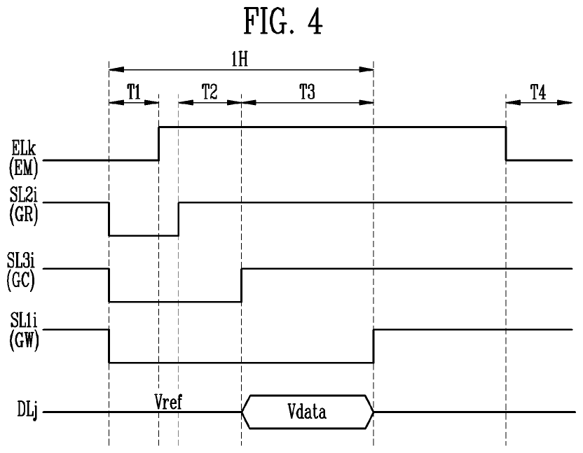

The data driver 140 may receive output data Dout and a data driving signal DCS from the timing controller 120. The data driving signal DCS may include a sampling signal and/or timing signals required for driving the data driver 140. The data driver 140 may generate data signals based on the data driving signal DCS and the output data Dout. For example, the data driver 140 may generate an analog data signal based on a grayscale value of the output data Dout. The data driver 140 may sequentially supply a voltage of reference power Vref and voltages of data signals Vdata to the data lines DL1 to DLm during one horizontal period 1H (refer to FIG. 4). The reference power Vref may be set as a constant voltage.

The emission driver 150 may receive an emission driving signal ECS from the timing controller 120. The emission driving signal ECS may include an emission start signal and clock signals required for driving the emission driver 150. The emission driver 150 may generate emission control signals EM while shifting the emission start signal in response to a clock signal.

For example, as illustrated in FIG. 2, the emission driver 150 may receive an emission start signal EFLM, and generate emission control signals EM while shifting the emission start signal EFLM in response to a clock signal. The emission driver 150 may successively supply the emission control signals to the emission control lines EL1 to ELo. The emission control signal may be set to a gate-off voltage, thus allowing the transistors included in the pixels PX to be turned off.

For example, an emission control signal of a high level may be supplied to a P-type transistor, and an emission control signal of a low level may be supplied to an N-type transistor. A transistor supplied with an emission control signal may be turned off in response to the emission control signal. Hereinafter, the supply of the emission control signal may mean that a gate-off voltage is supplied to the emission control line EL. No-supply of the emission control signal may indicate that a gate-on voltage is supplied to the emission control line EL.

The timing controller 120 may receive input data Din and a control signal CS from a host system through an interface. For example, the timing controller 120 may receive input data Din and a control signal CS from at least one of a graphics processing unit (GPU), a central processing unit (CPU), and an application processor (AP) that are included in the host system. The control signal CS may include various signals including a clock signal.

The timing controller 120 may generate a scan driving signal SCS, a data driving signal DCS, and an emission driving signal ECS based on the control signal CS. The scan driving signal SCS, the data driving signal DCS, and the emission driving signal ECS may be respectively supplied to the scan driver 130, the data driver 140, and the emission driver 150.

The timing controller 120 may rearrange the input data Din to match specifications of the display device 100. Furthermore, the timing controller 120 may correct the input data Din to generate output data Dout, and supply the output data Dout to the data driver 140. In an embodiment, the timing controller 120 may correct the input data Din in response to optical measurement results obtained during the manufacturing process.

The power supply 160 may generate various power voltages required for driving the display device 100. For example, the power supply 160 may generate first driving power VDD and second driving power VSS.

The first driving power VDD may be provided to supply driving current to the pixels PX. The second driving power VSS may be provided to receive the driving current from the pixels PX. During a period in which the pixels PX are set to an emission state, the first driving power VDD may be set to a voltage higher than that of the second driving power VSS.

The first driving power VDD generated from the power supply 160 may be supplied to the first power line PL1, and the second driving power VSS generated from the power supply 160 may be supplied to the second power line PL2. The first power line PL1 and the second power line PL2 may be connected in common to the pixels PX, but embodiments of the present disclosure are not limited thereto.

In an embodiment, the first power line PL1 may include a plurality of power lines. The power lines may be connected to different pixels PX. In an embodiment, the second power line PL2 may include a plurality of power lines. The power lines may be connected to different pixels PX. In other words, in an embodiment of the present disclosure, the pixels PX may be connected to any one of the first power lines PL1, and any one of the second power lines PL2.

FIG. 3 is a diagram illustrating a pixel PXij in accordance with an embodiment of the present disclosure. In FIG. 3, the pixel PXij is a pixel disposed in an i-th horizontal line and a j-th vertical line.

Referring to FIG. 3, the pixel PXij in accordance with an embodiment of the present disclosure may be connected to corresponding signal lines SL1i, SL2i, SL3i, ELk, and DLj. For example, the pixel PXij may be connected to the i-th first scan line SL1i, the i-th second scan line SL2i, the i-th third scan line SL3i, the k-th emission control line ELk, and the j-th data line DLj. In an embodiment, the pixel PXij may be also connected to the first power line PL1, and the second power line PL2.

The pixel PXij in accordance with an embodiment of the present disclosure may include a light emitting element LD, and a pixel circuit configured to control the amount of current supplied to the light emitting element LD.

The light emitting element LD may be connected between the first power line PL1 and the second power line PL2. For example, a first electrode (or an anode electrode) of the light emitting element LD may be electrically connected to the first power line PL1 via a third node N3, a fourth transistor M4, a second node N2, and a first transistor M1. A second electrode (or a cathode electrode) of the light emitting element LD may be electrically connected to the second power line PL2. The light emitting element LD may generate light of certain luminance corresponding to the amount of current that is supplied from the first power line PL1 to the second power line PL2 via the pixel circuit.

An organic light emitting diode may be used as the light emitting element LD. Furthermore, an inorganic light emitting diode such as a micro light emitting diode (LED) or a quantum dot light emitting diode may be used as the light emitting element LD. The light emitting element LD may be an element formed of a combination of organic material and inorganic material. Although FIG. 3 illustrates that the pixel PXij includes a single light emitting element LD, the pixel PXij in an embodiment may include a plurality of light emitting elements LD. The plurality of light emitting elements LD may be connected in series, parallel or series-parallel to each other.

The pixel circuit may include the first transistor M1, a second transistor M2, a third transistor M3, a fourth transistor M4, the fifth transistor M5, a sixth transistor M6, a first capacitor C1, and a second capacitor C2.

The first to sixth transistors M1 to M6 may be configured in various forms such as a metal-oxide semiconductor field effect transistor (MOSFET), a thin film transistor (TFT), a field effect transistor (FET), and a bipolar junction transistor (BJT).

In an embodiment, each of the first to sixth transistors M1 to M6 may be a P-type transistor. However, this is illustrative, and at least one of the first to sixth transistors M1 to M6 may be an N-type transistor.

The first transistor M1 (or a driving transistor) may include a first electrode electrically connected to the first power line PL1, and a second electrode connected to the second node N2. Here, the term “connected” implies being electrically linked or joined. A gate electrode of the first transistor M1 may be connected to a first node N1. The first transistor M1 may control the amount of current to be supplied from the first driving power VDD to the second driving power VSS via the light emitting element LD in response to the voltage of the first node N1.

The second transistor M2 may be connected between the data line DLj and a first electrode of the first capacitor C1. A gate electrode of the second transistor M2 may be electrically connected to the first scan line SL1i. When a first scan signal GW is supplied to the first scan line SL1i, the second transistor M2 may be turned on to electrically connect the data line DLj with the first electrode of the first capacitor C1.

The third transistor M3 may be connected between the data line DLj and the third node N3. A gate electrode of the third transistor M3 may be electrically connected to the second scan line SL2i. When a second scan signal GR is supplied to the second scan line SL2i, the third transistor M3 may be turned on to electrically connect the data line DLj with the third node N3.

The fourth transistor M4 may be connected between the second node N2 and the third node N3 (i.e., the first electrode of the light emitting element LD). A gate electrode of the fourth transistor M4 may be electrically connected to the emission control line ELk. The fourth transistor M4 may be turned off when an emission control signal EM is supplied to the emission control line ELk, and may be turned on when the emission control signal EM is not supplied thereto. If the fourth transistor M4 is turned off, the first transistor M1 and the light emitting element LD may be electrically disconnected from each other.

The fifth transistor M5 may be connected between the first node N1 and the second node N2. A gate electrode of the fifth transistor M5 may be electrically connected to the third scan line SL3i. When a third scan signal GC is supplied to the third scan line SL3i, the fifth transistor M5 may be turned on to electrically connect the first node N1 with the second node N2. In this case, the gate electrode of the first transistor M1 (i.e., the first node N1) and the second electrode of the first transistor M1 (i.e., the second node N2) may be electrically connected to each other, thus the firs transistor M1 is diode connected.

The sixth transistor M6 may include a first electrode connected to the first node N1, and a second electrode connected to the third node N3. A gate electrode of the sixth transistor M6 may be electrically connected to the second scan line SL2i. When a second scan signal GR is supplied to the second scan line SL2i, the sixth transistor M6 may be turned on to electrically connect the first node N1 with the third node N3.

The first electrode of the first capacitor C1 may be connected to the second electrode of the second transistor M2. A second electrode of the first capacitor C1 may be connected to the first node N1. The first capacitor may change the voltage of the first node N1 in response to a voltage supplied from the second transistor M2. For example, the first capacitor C1 may function as a coupling capacitor.

The second capacitor C2 may include a first electrode electrically connected to the first power line PL1, and a second electrode connected to the first node N1. In other words, the second capacitor C2 may be connected between the first power line PL1 and the first node N1. The second capacitor C2 may store the voltage of the first node N1.

FIG. 4 is a waveform diagram illustrating an embodiment of a method of driving the pixel PXij shown in FIG. 3.

Referring to FIG. 4, a horizontal period 1H (or a specific horizontal period) in which a data signal, which includes a voltage of reference power Vref and a voltage of a data signal Vdata, is supplied to the pixel PXij positioned on the i-th horizontal line and the j-th vertical line may include a first period T1, a second period T2, and a third period T3.

The data driver 140 may supply a voltage of the reference power Vref to the data line DLj during the first period T1 and the second period T2, and may supply a voltage Vdata of the data signal to the data line DLj during the third period T3. The reference power Vref may be set to a voltage between the first driving power VDD and the second driving power VSS. For example, the reference power Vref may be set to a voltage causing the light emitting element LD to be turned off when supplied to the first electrode of the light emitting element LD. The voltage Vdata of the data signal may be set to a certain voltage within the voltage range of the data signal according to a grayscale value.

The scan driver 130 (or the first scan driver 132) may supply a first scan signal GW to the first scan line SL1i during the first to third periods T1 to T3. The scan driver 130 (or the second scan driver 134) may supply a second scan signal GR to the second scan line SL2i during the first period T1. The scan driver 130 (or the third scan driver 136) may supply a third scan signal GC to the third scan line SL3i during the first period T1 and the second period T2. The emission driver 150 may supply an emission control signal EM to the emission control line ELk during the second period T2 and the third period T3.

During the first period T1, the voltage of the reference power Vref may be supplied to the first electrode of the first capacitor C1, the first node N1, the second node N2, and the third node N3. During the first period T1, the first capacitor C1, the second capacitor C2, and the light emitting element LD may be initialized by the voltage of the reference power Vref. The first period T1 may be referred to as an initialization period.

During the second period T2, a voltage corresponding to the threshold voltage of the first transistor M1 is stored in the second capacitor C2. The second period T2 may be referred to as a threshold voltage compensation period.

The third period T3 may be a period in which the voltage Vdata of the data signal is supplied from the data line DLj to the pixel PXij. During the third period T3, a voltage corresponding to the data signal may be applied to the first node N1. The third period T3 may be referred to as a data write period.

During the fourth period T4, the first transistor MI may control the amount of current flowing from the first driving power VDD to the second driving power VSS via the light emitting element LD in response to the voltage of the first node N1. During the fourth period T4, the light emitting element LD may emit light at a luminance corresponding to the amount of current supplied from the first transistor M1. The fourth period T4 may be referred to as an emission period.

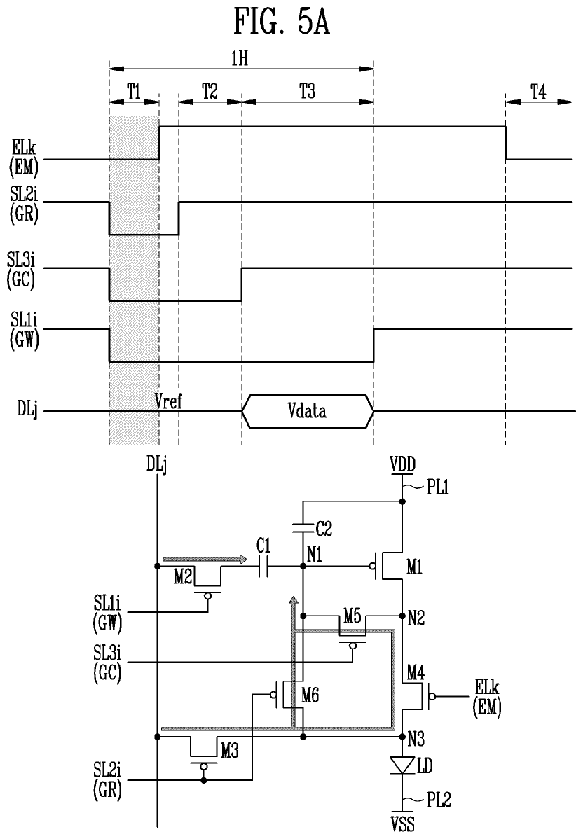

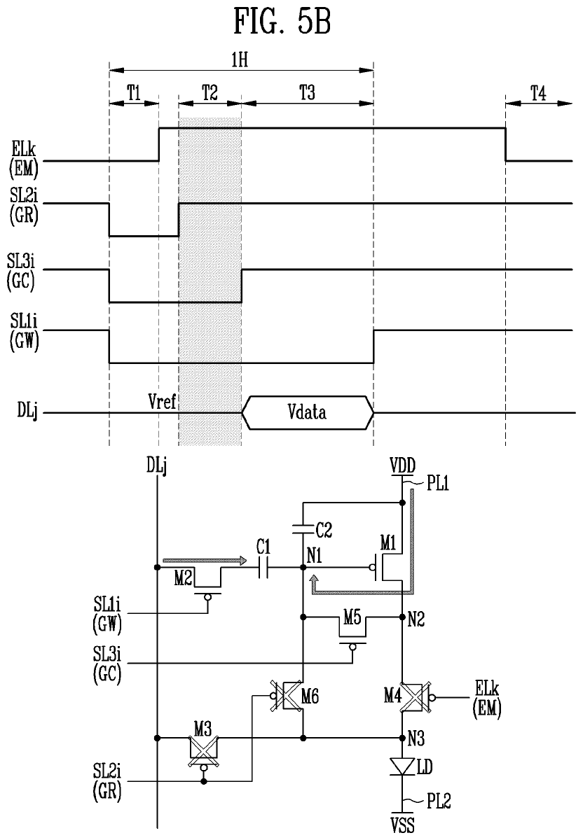

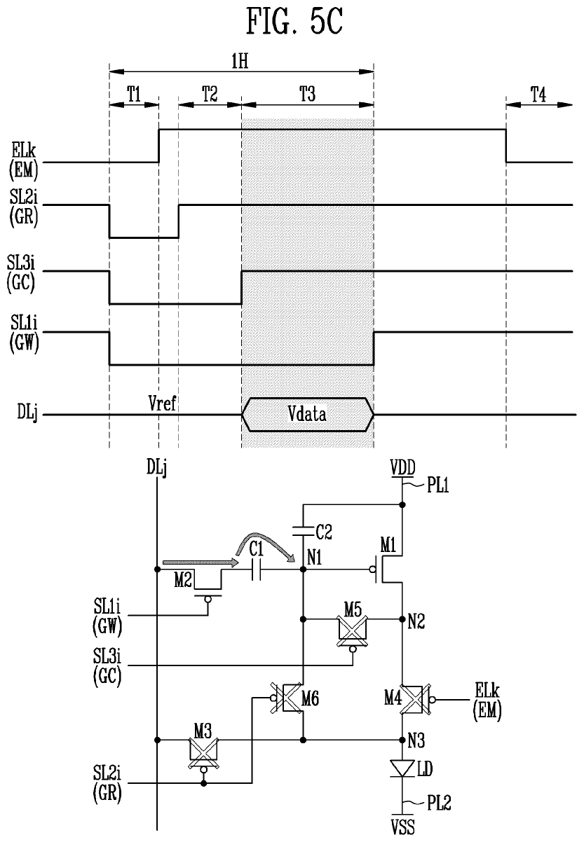

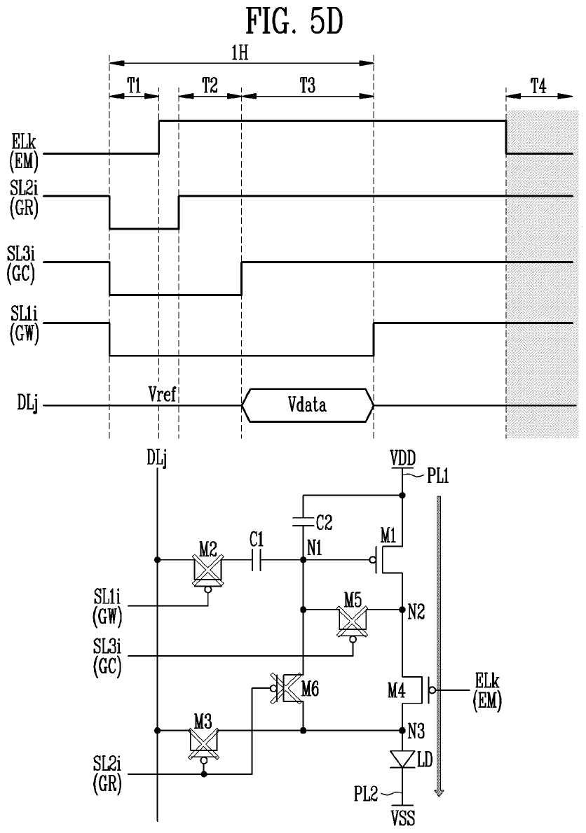

FIGS. 5A to 5D are diagrams illustrating an embodiment of a process of operating the pixel corresponding to the driving waveform in FIG. 4.

Referring to FIG. 5A, during the first period T1, the first scan signal GW is supplied to the first scan line SL1i, the second scan signal GR is supplied to the second scan line SL2i, and the third scan signal GC is supplied to the third scan line SL3i. During the first period T1, the emission control signal EM may not be supplied to the emission control line ELk.

If the first scan signal GW is supplied to the first scan line SL1i, the second transistor M2 is turned on. If the second transistor M2 is turned on, the voltage of the reference power Vref may be supplied from the data line DLj to the first electrode of the first capacitor C1.

If the second scan signal GR is supplied to the second scan line SL2i, the third transistor M3 and the sixth transistor M6 are turned on. If the third transistor M3 and the sixth transistor M6 are turned on, the voltage of the reference power Vref may be supplied from the data line DLj to the first node N1 and the third node N3.

If the voltage of the reference power Vref is supplied to the first node N1, the first capacitor C1 may be initialized by the voltage of the reference power Vref. For example, during the first period T1, the voltage of the reference power Vref is supplied to the first electrode and the second electrode of the first capacitor C1, whereby the first capacitor C1 may be initialized. Furthermore, if the voltage of the reference power Vref is supplied to the first node N1, the second capacitor C2 may be initialized to the voltage of the reference power Vref.

If the voltage of the reference power Vref is supplied to the third node N3, the light emitting element LD may be initialized by the voltage of the reference power Vref. For example, a parasitic capacitor (not shown) of the light emitting element LD may be discharged by the voltage of the reference power Vref. In addition, if the voltage of the reference power Vref is supplied to the third node N3, the light emitting element LD may be set to a non-emission state. To achieve the foregoing purpose, the voltage of the reference power Vref may be set such that the light emitting element LD does not emit light.

If the third scan signal GC is supplied to the third scan line SL3i, the fifth transistor M5 is turned on. If the fifth transistor M5 is turned on, the first node N1 and the second node N2 may be electrically connected to each other. Here, the second node N2 may be initialized to the voltage of the reference power Vref.

If the emission control signal EM is not supplied to the emission control line ELk, the fourth transistor M4 is set to a turn-on state. If the fourth transistor M4 is turned on, the second node N2 and the third node N3 may be electrically connected to each other.

During the first period T1, the second to sixth transistors M2 to M6 are set to a turn-on state. Consequently, the voltage of the reference power Vref may be supplied from the data line DLj to the first node N1, the second node N2, and the third node N3. As a result, the first capacitor C1, the second capacitor C2, and the light emitting element LD may be initialized by the voltage of the reference power Vref.

Referring to FIG. 5B, during the second period T2, the first scan signal GW is supplied to the first scan line SL1i, so that the second transistor M2 may remain turned on. During the second period T2, the third scan signal GC is supplied to the third scan line SL3i, so that the fifth transistor M5 may remain turned on.

During the second period T2, the supply of the second scan signal GR to the second scan line SL2i is interrupted. If the supply of the second scan signal GR to the second scan line SL2i is interrupted, the third transistor M3 and the sixth transistor M6 are turned off.

During the second period T2, the emission control signal EM is supplied to the emission control line ELk. If the emission control signal EM is supplied to the emission control line ELk, the fourth transistor M4 is turned off.

If the fifth transistor M5 is turned on, the first transistor M1 is diode connected. If the first transistor M1 is diode connected, a voltage acquired by subtracting the absolute threshold voltage of the first transistor M1 from the first driving power VDD may be applied to the first node N1.

If the second transistor M2 is turned on, the voltage of the reference power Vref is supplied to the first electrode of the first capacitor C1. As a result, during the second period T2, a voltage corresponding to the threshold voltage of the first transistor M1 may be stored in each of the first capacitor C1 and the second capacitor C2.

Referring to FIG. 5C, during the third period T3, the first scan signal GW is supplied to the first scan line SL1i, so that the second transistor M2 may remain turned on.

If the second transistor M2 is turned on, a voltage Vdata of a data signal is supplied from the data line DLj to the first electrode of the first capacitor C1. If the voltage Vdata of the data signal is supplied to the first electrode of the first capacitor C1, the first electrode of the first capacitor C1 changes from the voltage of the reference power Vref to the voltage Vdata of the data signal. In this case, the voltage of the first node N1 may also change due to the coupling of the first capacitor C1.

Here, voltage change of the first node N1 may be determined according to a ratio of the first capacitor C1 and the second capacitor C2. For example, the voltage of the first node N1 may change from the voltage obtained by subtracting the absolute threshold voltage of the first transistor M1 from the first driving power VDD by a value resulting from multiplying the voltage change of the first electrode of the first capacitor C1 by C1/(C1+C2). In the case where the voltage change of the first node N1 is controlled by the ratio of the first capacitor C1 and the second capacitor C2, the voltage range of the data signal may be sufficiently widened.

For example, in the case where the data signal is directly supplied to the gate electrode of the first transistor M1, the voltage range of the data signal may be set to a relatively narrow range. In the case where the data signal has a narrow voltage range, there is a need to implement various grayscale values (e.g., 256 values) using the narrow voltage range. Consequently, it becomes difficult to represent accurate grayscale values.

On the other hand, as described in embodiments of the present disclosure, in the case where a voltage to be supplied to the gate electrode of the first transistor M1 is controlled by the ratio of the first capacitor C1 and the second capacitor C2, the voltage range of the data signal may be set to a sufficiently wide range. For example, a voltage corresponding to a value obtained by multiplying the voltage of the data signal by C1/(C1+C2) is transmitted to the gate electrode of the first transistor M1. Consequently, the voltage range of the data signal may be set to a wide range. In the case where the data signal has a wide voltage range, grayscale values may be easily implemented.

During the third period T3, the second capacitor C2 stores the voltage of the first node N1. Here, the voltage of the first node N1 may be determined by the threshold voltage of the first transistor M1 and the voltage Vdata of the data signal. Consequently, during the third period T3, a voltage corresponding to the data signal and the threshold voltage of the first transistor M1 may be stored in the second capacitor C2. In addition, during the third period T3, the third to sixth transistors M3 to M6 are set to a turn-off state.

Referring to FIG. 5D, during the fourth period T4, the scan signals GW, GR, and GC are not supplied to the scan lines SL1i, SL2i, and SL3i. In this case, the second transistor M2, the third transistor M3, the fifth transistor M5, and the sixth transistor M6 are turned off.

During the fourth period T4, the supply of the emission control signal EM to the emission control line ELk is interrupted. Hence, the fourth transistor M4 is turned on. If the fourth transistor M4 is turned on, the first transistor M1 and the light emitting element LD may be electrically connected to each other.

Because the fourth transistor M4 is set to a turn-on state, current provided from the first transistor M1 may be supplied to the light emitting element LD. In other words, during the fourth period T4, the first transistor MI may control the amount of current flowing from the first driving power VDD to the second driving power VSS via the light emitting element LD in response to the voltage of the first node N1. The light emitting element LD may emit light in proportional to the amount of current supplied from the first transistor M1.

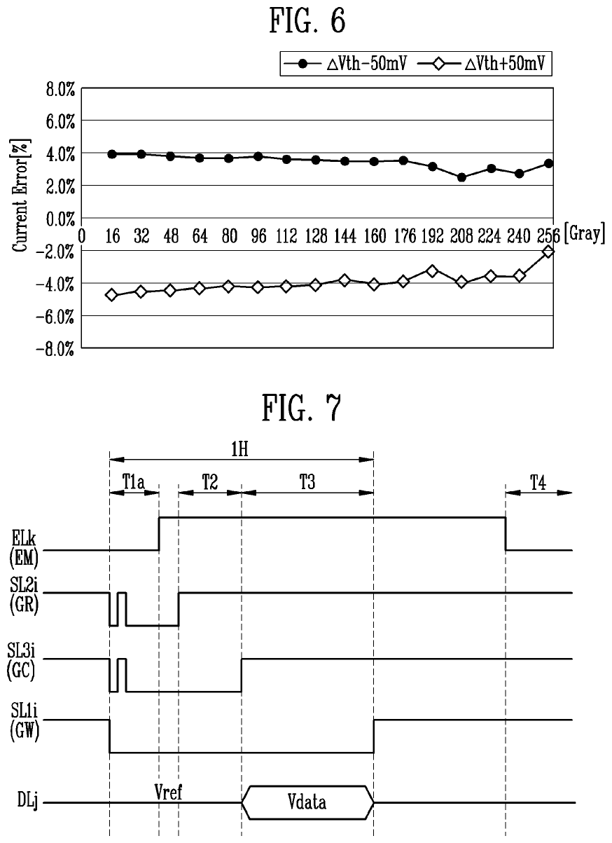

FIG. 6 is a diagram illustrating a current error of the pixel shown in FIG. 3. In FIG. 6, the X-axis denotes the grayscale, and the Y-axis denotes the current error. The current error is expressed as a percentage [%] and represents variation in driving current in response to a change in threshold voltage of the first transistor M1. For example, FIG. 6 illustrates the current error when the threshold voltage of the first transistor M1 changes by −50 mV or +50 mV.

Referring to FIG. 6, when the threshold voltage of the first transistor MI changes by −50 mV or +50 mV, the current error may be set to approximately −4.56% to +4%. In other words, the pixel PXij according to an embodiment of the present disclosure may reliably compensate for the threshold voltage of the first transistor M1.

FIG. 7 is a diagram illustrating an embodiment of a method of driving the pixel shown in FIG. 3. In the following description of FIG. 7, redundant explanation pertaining to the same configuration as that of FIG. 4 will be omitted.

Referring to FIGS. 3 and 7, a horizontal period 1H (or a specific horizontal period) in which a data signal is supplied to the pixel PXij positioned on the i-th horizontal line and the j-th vertical line may include a first period T1a, a second period T2, and a third period T3.

During the first period T1a, the second scan signal GR may be supplied to the second scan line SL2i at least two times. For example, during the first period T1a, a gate-on voltage, a gate-off voltage, and a gate-on voltage may be sequentially supplied to the second scan line SL2i. In this case, during the first period T1a, the third transistor M3 and the sixth transistor M6 may be sequentially set to a turn-on state, a turn-off state, and a turn-on state.

During the first period T1a, the third scan signal GC may be supplied to the third scan line SL3i at least two times. For example, during the first period T1a, a gate-on voltage, a gate-off voltage, and a gate-on voltage may be sequentially supplied to the third scan line SL3i.

In this case, during the first period T1a, the fifth transistor M5 may be sequentially set to a turn-on state, a turn-off state, and a turn-on state. Here, a turn-on period of the third transistor M3, a turn-on period of the sixth transistor M6, and a turn-on period of the fifth transistor M5 may overlap each other during the first period T1a.

In addition, during the first period T1a, the second transistor M2 may be set to a turn-on state by the first scan signal GW supplied to the first scan line SL1i. Furthermore, during the first period T1a, the emission control signal EM is not supplied to the emission control line ELk. Hence, the fourth transistor M4 may be set to a turn-on state.

During the first period T1a, if the second to sixth transistors M2 to M6 are turned on, as illustrated in FIG. 5A, the voltage of the reference voltage Vref may be supplied to the first node N1, the second node N2, and the third node N3, thus allowing the first capacitor C1, the second capacitor C2, and the light emitting element LD to be initialized.

During the first period T1a, if the third transistor M3, the fifth transistor M5, and the sixth transistor M6 are turned off, the reference power Vref is not supplied to the first node N1, the second node N2, and the third node N3.

In the driving method illustrated in FIG. 7, during the first period T1a, the second scan signal GR and the third scan signal GC may be supplied multiple times (or the third transistor M3, the fifth transistor M5, and the sixth transistor M6 may be turned off at least one time), and the first node N1, the second node N2, and the third node N3 may be initialized at least two times. In this case, the first capacitor C1, the second capacitor C2, and the light emitting element LD may be more reliably initialized.

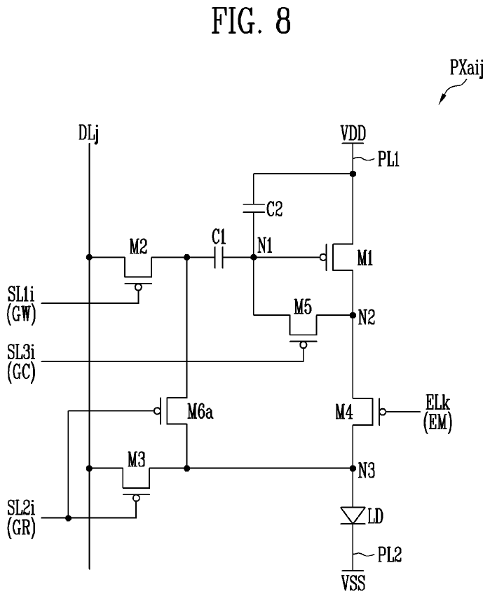

FIG. 8 is a diagram illustrating a pixel PXij in accordance with an embodiment of the present disclosure. In FIG. 8, the pixel PXij is disposed in an i-th horizontal line and a j-th vertical line. In the following description of FIG. 8, redundant explanation pertaining to the same configuration as that of FIG. 3 will be omitted.

Referring to FIG. 8, the pixel PXaij in accordance with an embodiment of the present disclosure may be connected to corresponding signal lines SL1i, SL2i, SL3i, ELk, and DLj. For example, the pixel PXaij may be connected to the i-th first scan line SL1i, the i-th second scan line SL2i, the i-th third scan line SL3i, the k-th emission control line ELk, and the j-th data line DLj. In an embodiment, the pixel PXaij may be also connected to the first power line PL1, and the second power line PL2.

The pixel PXaij in accordance with an embodiment of the present disclosure may include a light emitting element LD, and a pixel circuit configured to control the amount of current to be supplied to the light emitting element LD.

The light emitting element LD may be connected between the first power line PL1 and

the second power line PL2. The light emitting element LD may generate light of certain luminance corresponding to the amount of current that is supplied from the first power line PL1 to the second power line PL2 via the pixel circuit.

The pixel circuit may include a first transistor M1, a second transistor M2, a third transistor M3, a fourth transistor M4, a fifth transistor M5, a sixth transistor M6a, a first capacitor C1, and a second capacitor C2.

A first electrode of the sixth capacitor M6a may be connected to the first electrode of the first capacitor C1. A second electrode of the sixth capacitor M6a may be connected to the third node N3. A gate electrode of the sixth transistor M6a may be electrically connected to the second scan line SL2i. When a second scan signal GR is supplied to the second scan line SL2i, the sixth transistor M6a may be turned on to electrically connect the first electrode of the first capacitor C1 with the third node N3.

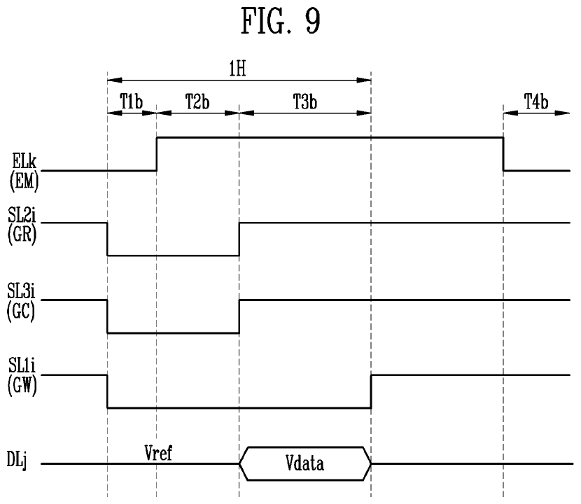

FIG. 9 is a diagram illustrating an embodiment of a method of driving the pixel PXaij shown in FIG. 8.

Referring to FIG. 9, a horizontal period 1H (or a specific horizontal period) in which a data signal, which includes a voltage of reference power Vref and a voltage of a data signal Vdata, is supplied to the pixel PXaij positioned on the i-th horizontal line and the j-th vertical line may include a first period T1b, a second period T2b, and a third period T3b.

The data driver 140 may supply a voltage of the reference power Vref to the data line DLj during the first period T1b and the second period T2b, and may supply a voltage of the data signal Vdata to the data line DLj during the third period T3b. The reference power Vref may be set to a voltage between the first driving power VDD and the second driving power VSS. For example, the reference power Vref may be set to a voltage causing the light emitting element LD to be turned off when supplied to the first electrode of the light emitting element LD. The voltage Vdata of the data signal may be set to a certain voltage within the voltage range of the data signal in response to a grayscale value.

The scan driver 130 (or the first scan driver 132) may supply a first scan signal GW to the first scan line SL1i during the first to third periods T1b to T3b. The scan driver 130 (or the second scan driver 134) may supply a second scan signal GR to the second scan line SL2i during the first period T1b and the second period T2b. The scan driver 130 (or the third scan driver 136) may supply a third scan signal GC to the third scan line SL3i during the first period T1b and the second period T2b. The emission driver 150 may supply an emission control signal EM to the emission control line ELk during the second period T2b and the third period T3b.

During the first period T1b, the voltage of the reference power Vref may be supplied to the first electrode of the first capacitor C1, the first node N1, the second node N2, and the third node N3. During the first period T1b, the first capacitor C1, the second capacitor C2, and the light emitting element LD may be initialized by the voltage of the reference power Vref. The first period T1b may be referred to as an initialization period.

During the second period T2b, a voltage corresponding to the threshold voltage of the first transistor M1 is stored in the second capacitor C2. The second period T2b may be referred to as a threshold voltage compensation period.

The third period T3b may be a period in which the voltage Vdata of the data signal is supplied from the data line DLj to the pixel PXaij. During the third period T3b, a voltage corresponding to the data signal may be applied to the first node N1. The third period T3b may be referred to as a data write period.

During the fourth period T4b, the first transistor M1 may control the amount of current flowing from the first driving power VDD to the second driving power VSS via the light emitting element LD in response to the voltage of the first node N1. During the fourth period T4b, the light emitting element LD may emit light at a luminance corresponding to the amount of current supplied from the first transistor M1. The fourth period T4b may be referred to as an emission period.

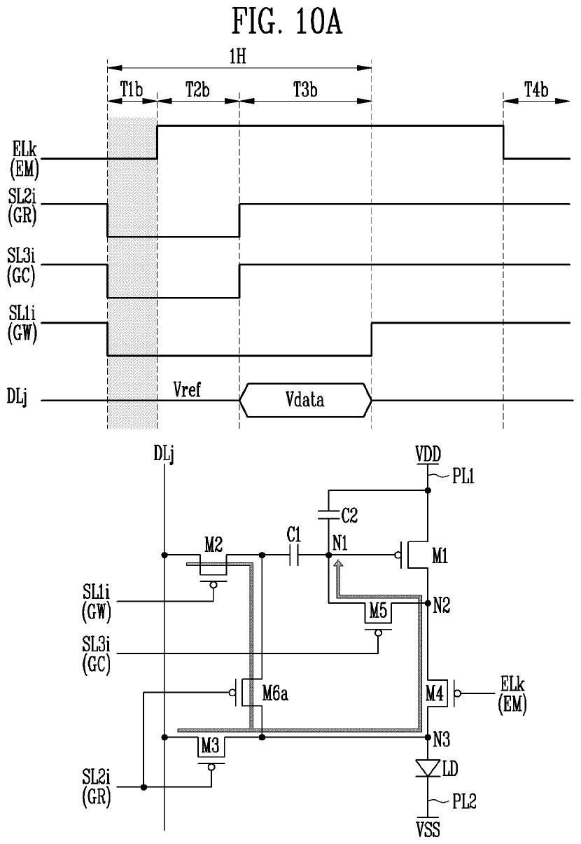

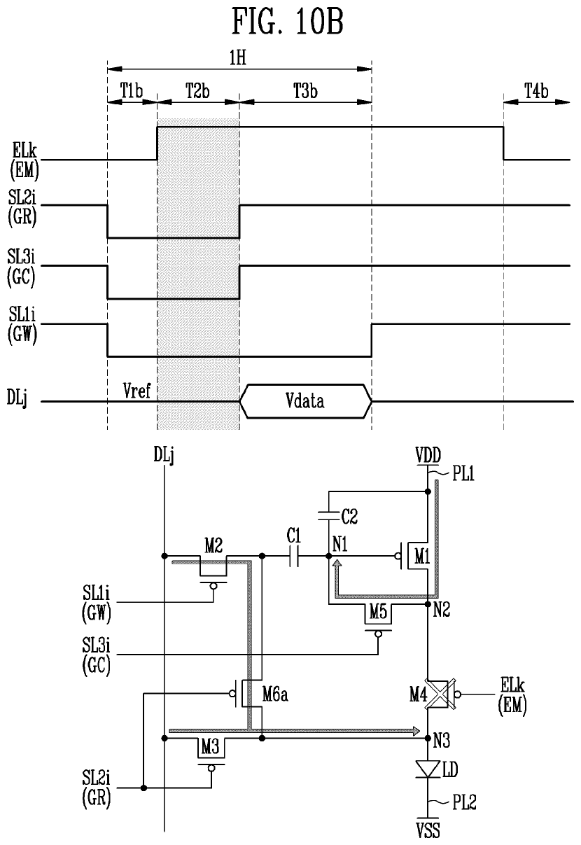

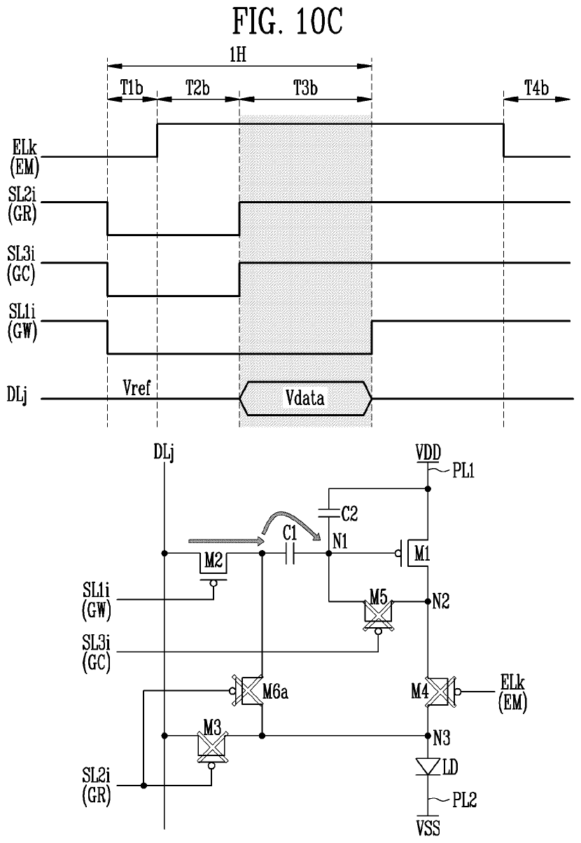

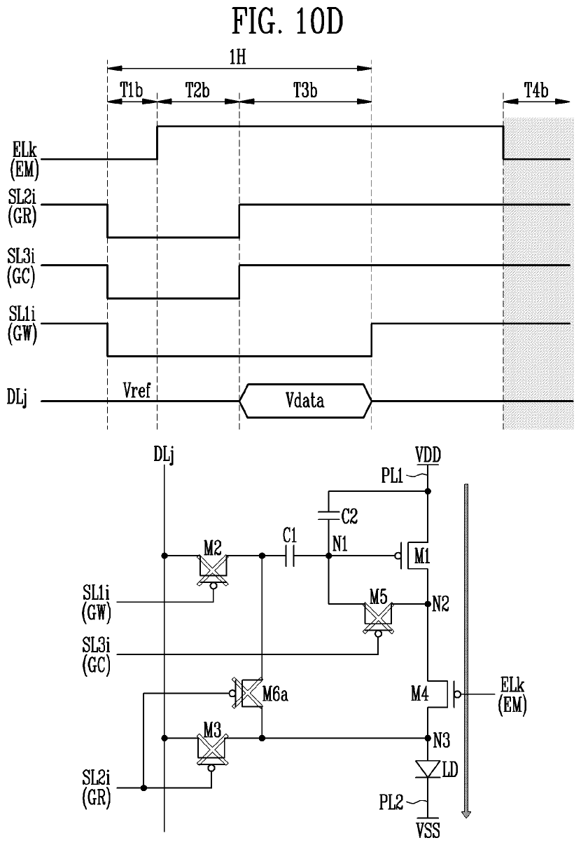

FIGS. 10A to 10D are diagrams illustrating an embodiment of a process of operating the pixel corresponding to the driving waveform in FIG. 9.

Referring to FIG. 10A, during the first period T1b, the first scan signal GW is supplied to the first scan line SL1i, the second scan signal GR is supplied to the second scan line SL2i, and the third scan signal GC is supplied to the third scan line SL3i. During the first period T1b, the emission control signal EM may not be supplied to the emission control line ELk.

If the first scan signal GW is supplied to the first scan line SL1i, the second transistor M2 is turned on. If the second transistor M2 is turned on, the voltage of the reference power Vref may be supplied from the data line DLj to the first electrode of the first capacitor C1.

If the second scan signal GR is supplied to the second scan line SL2i, the third transistor M3 and the sixth transistor Moa are turned on. If the third transistor M3 and the sixth transistor M6a are turned on, the voltage of the reference power Vref may be supplied from the data line DLj to the third node N3.

If the third scan signal GC is supplied to the third scan line SL3i, the fifth transistor M5 is turned on. If the fifth transistor M5 is turned on, the first node N1 and the second node N2 may be electrically connected to each other.

If the emission control signal EM is not supplied to the emission control line ELk, the fourth transistor M4 is set to a turn-on state. If the fourth transistor M4 is turned on, the second node N2 and the third node N3 may be electrically connected to each other.

During the first period T1b, the second to sixth transistors M2 to M6a are set to a turn-

on state. Consequently, the voltage of the reference power Vref may be supplied from the data line DLj to the first electrode of the first capacitor C1, the first node N1, the second node N2, and the third node N3. As a result, the first capacitor C1, the second capacitor C2, and the light emitting element LD may be initialized by the voltage of the reference power Vref.

Referring to FIG. 10B, during the second period T2b, the first scan signal GW is supplied to the first scan line SL1i, so that the second transistor M2 may remain turned on. During the second period T2b, the second scan signal GR is supplied to the second scan line SL2i, so that the third transistor M3 and the sixth transistor M6a may remain turned on. During the second period T2b, the third scan signal GC is supplied to the third scan line SL3i, so that the fifth transistor M5 may remain turned on.

During the second period T2b, the emission control signal EM is supplied to the emission control line ELk. If the emission control signal EM is supplied to the emission control line ELk, the fourth transistor M4 is turned off.

If the fifth transistor M5 is turned on by the third scan signal GC, the first transistor M1 is diode connected. If the first transistor M1 is diode connected, a voltage acquired by subtracting the absolute threshold voltage of the first transistor M1 from the first driving power VDD may be applied to the first node N1.

If the second transistor M2 is turned on, the voltage of the reference power Vref is

supplied to the first electrode of the first capacitor C1. As a result, during the second period T2, a voltage corresponding to the threshold voltage of the first transistor M1 may be stored in each of the first capacitor C1 and the second capacitor C2.

If the third transistor M3 and the sixth transistor M6a are turned on, the voltage of the reference power Vref is supplied to the third node N3. As a result, the light emitting element LD may be initialized by the reference power Vref.

Referring to FIG. 10C, during the third period T3b, the first scan signal GW is supplied to the first scan line SL1i, so that the second transistor M2 may remain turned on.

If the second transistor M2 is turned on, a voltage Vdata of a data signal is supplied from the data line DLj to the first electrode of the first capacitor C1. If the voltage Vdata of the data signal is supplied to the first electrode of the first capacitor C1, the first electrode of the first capacitor C1 changes from the voltage of the reference power Vref to the voltage Vdata of the data signal. In this case, the voltage of the first node NI may also change due to the coupling the first capacitor C1.

Here, voltage change of the first node N1 may be determined according to a ratio of the first capacitor C1 and the second capacitor C2. For example, the voltage of the first node N1 may change from the voltage obtained by subtracting the absolute threshold voltage of the first transistor M1 from the first driving power VDD, by a value resulting from multiplying the voltage change of the first electrode of the first capacitor C1 by C1/(C1+C2). In the case where the voltage change of the first node NI is controlled by the ratio of the first capacitor C1 and the second capacitor C2, the voltage range of the data signal may be sufficiently widened.

During the third period T3b, the second capacitor C2 stores the voltage of the first node N1. Here, the voltage of the first node NI may be determined by the threshold voltage of the first transistor M1 and the voltage Vdata of the data signal. Consequently, during the third period T3b, a voltage corresponding to the data signal and the threshold voltage of the first transistor M1 may be stored in the second capacitor C2. In addition, during the third period T3b, the third to sixth transistors M3 to M6a are set to a turn-off state.

Referring to FIG. 10D, during the fourth period T4b, the scan signals GW, GR, and GC are not supplied to the scan lines SL1i, SL2i, and SL3i. In this case, the second transistor M2, the third transistor M3, the fifth transistor M5, and the sixth transistor M6a are turned off.

During the fourth period T4b, the supply of the emission control signal EM to the emission control line Elk is interrupted. Hence, the fourth transistor M4 is turned on. If the fourth transistor M4 is turned on, the first transistor MI and the light emitting element LD may be electrically connected to each other.

Because the fourth transistor M4 is set to a turn-on state, current provided from the first transistor M1 may be supplied to the light emitting element LD. In other words, during the fourth period T4b, the first transistor M1 may control the amount of current flowing from the first driving power VDD to the second driving power VSS via the light emitting element LD in response to the voltage of the first node N1. The light emitting element LD may emit light in proportional to the amount of current supplied from the first transistor M1.

In an embodiment of the present disclosure, the pixel PXaij shown in FIG. 8 may also be driven in the driving waveform shown in FIG. 4. In this case, during the second period T2, the supply of the second scan signal GR is interrupted, whereby the third transistor M3 and the sixth transistor M6a can be turned off. Even if the third transistor M3 and the sixth transistor M6a are turned off, the threshold voltage of the first transistor M1 may be reliably compensated for during the second period T2.

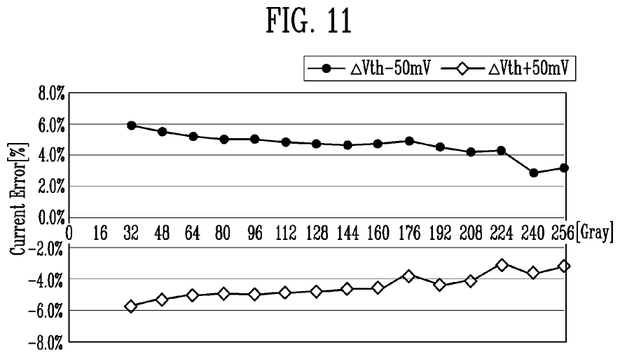

FIG. 11 is a diagram illustrating a current error of the pixel shown in FIG. 8. In FIG. 11, the X-axis denotes the grayscale, and the Y-axis denotes the current error. The current error is expressed as a percentage [%] and represents variation in driving current in response to a change in threshold voltage of the first transistor M1. For example, FIG. 11 illustrates the current error when the threshold voltage of the first transistor M1 changes by −50 mV or +50 mV.

Referring to FIG. 11, when the threshold voltage of the first transistor M1 changes by −50 mV or +50 mV, the current error may be set to approximately −5.73% to +5.95%. In other words, the pixel PXaij according to an embodiment of the present disclosure may reliably compensate for the threshold voltage of the first transistor M1.

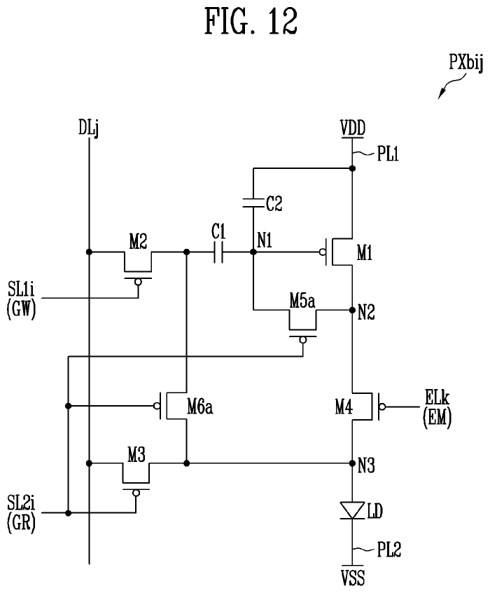

FIG. 12 is a diagram illustrating a pixel PXbij in accordance with an embodiment of the present disclosure. In FIG. 12, the pixel PXbij is disposed in an i-th horizontal line and a j-th vertical line. In the following description of FIG. 12, redundant explanation pertaining to the same configuration as that of FIG. 8 will be omitted.

Referring to FIG. 12, the pixel PXbij in accordance with an embodiment of the present disclosure may be connected to corresponding signal lines SL1i, SL2i, ELk, and DLj. For example, the pixel PXbij may be connected to the i-th first scan line SL1i, the i-th second scan line SL2i, the k-th emission control line ELk, and the j-th data line DLj. In an embodiment, the pixel PXbij may be also connected to the first power line PL1, and the second power line PL2.

The pixel PXbij in accordance with an embodiment of the present disclosure may include a light emitting element LD, and a pixel circuit configured to control the amount of current to be supplied to the light emitting element LD.

The light emitting element LD may be connected between the first power line PL1 and the second power line PL2. The light emitting element LD may generate light of certain luminance corresponding to the amount of current that is supplied from the first power line PL1 to the second power line PL2 via the pixel circuit.

The pixel circuit may include the first transistor M1, a second transistor M2, a third transistor M3, a fourth transistor M4, the fifth transistor M5a, a sixth transistor M6a, a first capacitor C1, and a second capacitor C2.

The fifth transistor M5a is coupled between the first node N1 and the second node N2. A gate electrode of the fifth transistor M5a may be electrically connected to the second scan line SL2i. When a second scan signal GR is supplied to the second scan line SL2i, the fifth transistor M5a may be turned on to electrically connect the first node NI with the second node N2.

Compared to the pixel PXaij in FIG. 8, the general configuration of the pixel PXbij in FIG. 12, other than a structure in which the fifth transistor M5a is connected to the second scan line SL2i, is the same as that of the pixel PXaij. In the case where the fifth transistor M5a is connected to the second scan line SL2i, the third scan line SL3i shown in FIG. 8 may be omitted.

As illustrated in FIG. 9, the second scan signal GR and the third scan signal GC are supplied at the same timing. Hence, the driving method of the pixel PXbij in FIG. 12 is the same as the pixel PXaij in FIG. 8. Therefore, detailed description of the driving method of the pixel PXbij in FIG. 12 will be omitted.

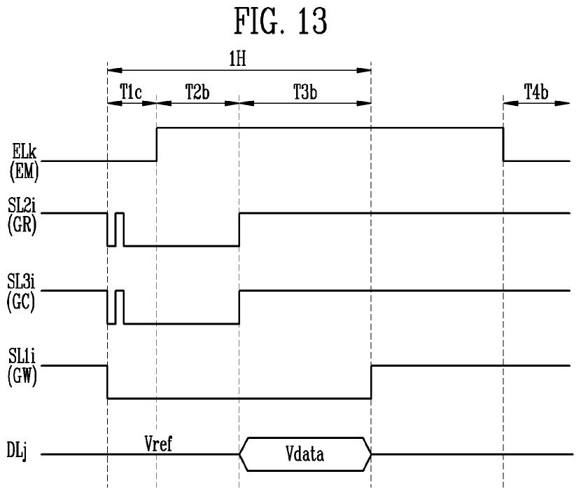

FIG. 13 is a diagram illustrating an embodiment of a method of driving the pixel PXaij shown in FIG. 8. In the following description of FIG. 13, redundant explanation pertaining to the same configuration as that of FIG. 9 will be omitted.

Referring to FIGS. 8 and 13, a horizontal period 1H (or a specific horizontal period) in which a data signal, which includes a voltage of reference power Vref and a voltage of a data signal Vdata, is supplied to the pixel PXaij positioned on the i-th horizontal line and the j-th vertical line may include a first period T1c, a second period T2b, and a third period T3b.

During the first period T1c, the second scan signal GR may be supplied to the second scan line SL2i at least two times. For example, during the first period T1c, a gate-on voltage, a gate-off voltage, and a gate-on voltage may be sequentially supplied to the second scan line SL2i. In this case, during the first period T1c, the third transistor M3 and the sixth transistor M6a may be sequentially set to a turn-on state, a turn-off state, and a turn-on state.

During the first period T1c, the third scan signal GC may be supplied to the third scan line SL3i at least two times. For example, during the first period T1c, a gate-on voltage, a gate-off voltage, and a gate-on voltage may be sequentially supplied to the third scan line SL3i. In this case, during the first period T1c, the fifth transistor M5 may be sequentially set to a turn-on state, a turn-off state, and a turn-on state. Here, a turn-on period of the third transistor M3, a turn-on period of the sixth transistor M6a, and a turn-on period of the fifth transistor M5 may overlap each other.

In addition, during the first period T1c, the second transistor M2 may be set to a turn-on state by the first scan signal GW supplied to the first scan line SL1i. Furthermore, during the first period T1c, the emission control signal EM is not supplied to the emission control line ELk. Hence, the fourth transistor M4 may be set to a turn-on state.

During the first period T1c, if the second to sixth transistors M2 to M6 are turned on, as illustrated in FIG. 10A, the voltage of the reference voltage Vref may be supplied to the first node N1, the second node N2, and the third node N3, thus allowing the first capacitor C1, the second capacitor C2, and the light emitting element LD to be initialized.

During the first period T1c, if the third transistor M3, the fifth transistor M5, and the sixth transistor M6 are turned off, the reference power Vref is not supplied to the first node N1, the second node N2, and the third node N3.

In the driving method illustrated in FIG. 13, during the first period T1c, the second scan signal GR and the third scan signal GC may be supplied multiple times (or the third transistor M3, the fifth transistor M5, and the sixth transistor M6a may be turned off at least one time), and the first node N1, the second node N2, and the third node N3 may be initialized at least two times. In this case, the first capacitor C1, the second capacitor C2, and the light emitting element LD may be more reliably initialized.

A pixel in accordance with embodiments of the present disclosure may compensate for the threshold voltage of a driving transistor using six transistors and two capacitors. As a result, the pixel may be applied to high-resolution display devices.

The pixel in accordance with embodiments of the present disclosure may transmit data signals using capacitor coupling, whereby a voltage range of the data signal may be set to a relatively large range.

However, effects of the present disclosure are not limited to the above-described effects, and various modifications are possible without departing from the spirit and scope of the present disclosure.

While embodiments of the present disclosure have been described above, those skilled in the art will appreciate that various modifications, additions and substitutions are possible, without departing from the scope and spirit of the present disclosure claimed in the appended claims.

What is claimed is:

1. A pixel comprising:
a first transistor including a gate electrode connected to a first node, a first electrode electrically connected to a first power line configured to supply first driving power, and a second electrode connected to a second node;
a second transistor including a first electrode electrically connected to a data line, a second electrode, and a gate electrode electrically connected to a first scan line;
a third transistor connected between the data line and a third node, and including a gate electrode electrically connected to a second scan line;
a fourth transistor connected between the second node and the third node, and including a gate electrode electrically connected to an emission control line;
a first capacitor including a first electrode connected to the second electrode of the second transistor and a second electrode connected to the first node;
a second capacitor connected between the first power line and the first node; and
a light emitting element connected between the third node and a second power line configured to supply second driving power.

2. The pixel according to claim 1, further comprising a fifth transistor connected between the first node and the second node, and including a gate electrode electrically connected to a third scan line.

3. The pixel according to claim 2, further comprising a sixth transistor connected between the first node and the third node, and including a gate electrode electrically connected to the second scan line.

4. The pixel according to claim 3, wherein, during at least a partial period of a first period of a horizontal period in which a data signal is supplied to the pixel, the second to the sixth transistors are set to a turn-on state, and
wherein, during the first period, a voltage of reference power having a voltage value between the first diving power and the second driving power is supplied to the data line.

5. The pixel according to claim 4, wherein, during the first period, the third transistor, the fifth transistor, and the sixth transistor are set to a turn-off state at least one time.

6. The pixel according to claim 4, wherein, during a second period following the first period in the horizontal period, the second transistor and the fifth transistor are set to the turn-on state, and
wherein, during the second period, the voltage of the reference power is supplied to the data line.

7. The pixel according to claim 6, wherein, during a third period following the second period in the horizontal period, the second transistor is set to the turn-on state, and
wherein, during the third period, a voltage of the data signal is supplied to the data line.

8. The pixel according to claim 2, further comprising a sixth transistor connected between the first node and the third node, and including a gate electrode electrically connected to the second scan line.

9. The pixel according to claim 8, wherein the third scan line is a scan line identical to the second scan line.

10. The pixel according to claim 8, wherein, during at least a partial period of a first period of a horizontal period in which a data signal is supplied to the pixel, the second to the sixth transistors are set to the turn-on state, and
wherein, during the first period, the voltage of the reference power having a voltage value between the first diving power and the second driving power is supplied to the data line.

11. The pixel according to claim 10, wherein, during the first period, the third transistor, the fifth transistor, and the sixth transistor are set to a turn-off state at least one time.

12. The pixel according to claim 10, wherein, during the second period following the first period in the horizontal period, the second transistor, the third transistor, the fifth transistor, and the sixth transistor are set to the turn-on state, and
wherein, during the second period, the voltage of the reference power is supplied to the data line.

13. The pixel according to claim 12, wherein, during a third period following the second period in the horizontal period, the second transistor is set to the turn-on state, and
wherein, during the third period, the voltage of the data signal is supplied to the data line.

14. A display device comprising pixels connected to first scan lines, second scan lines, third scan lines, data lines, and emission control lines, wherein a pixel disposed in an i-th pixel row (i is an integer of 0 or more) and a j-th pixel column (j is an integer of 0 or more) comprises:
a first transistor including a gate electrode connected to a first node, a first electrode electrically connected to a first power line configured to supply first driving power, and a second electrode connected to a second node;
a second transistor including a first electrode electrically connected to a j-th data line and a second electrode, and configured to be turned on in response to a first scan signal supplied from an i-th first scan line;
a third transistor connected between the j-th data line and a third node, and configured to be turned on in response to a second scan signal supplied from an i-th second scan line;
a fourth transistor connected between the second node and the third node, and configured to be turned off in response to an emission control signal supplied from a k-th emission control line (where k is an integer of 0 or more);
a first capacitor including a first electrode connected to the second electrode of the second transistor and the first node;
a second capacitor connected between the first power line and the first node; and
a light emitting element connected between the third node and a second power line configured to supply second driving power.

15. The display device according to claim 14, wherein the pixel disposed in the i-th pixel row and the j-th pixel column further comprises:
a fifth transistor connected between the first node and the second node, and configured to be turned on in response to a third scan signal supplied from an i-th third scan line; and
a sixth transistor connected between the first node and the third node, and configured to be turned on in response to the second scan signal supplied from the i-th second scan line.

16. The display device according to claim 15, wherein a horizontal period in which a data signal is supplied the pixel disposed in the i-th pixel row and the j-t h pixel column includes a first period, a second period, and a third period, and
wherein the display device further comprising:
a data driver configured to supply a voltage of reference power having a voltage value between the first driving power and the second driving power to the j-th data line during the first period and the second period, and supply the data signal to the j-th data line during the third period;
a first scan driver configured to supply the first scan signal to the i-th first scan line during the first to the third periods;
a second scan driver configured to supply the second scan signal to the i-th second scan line during the first period;
a third scan driver configured to supply the third scan signal to the i-th third scan line during the first period and the second period; and
an emission driver configured to supply the emission control signal to the k-th emission control line during the second period and the third period.

17. The display device according to claim 16, wherein the second scan driver supplies a gate-off voltage to the i-th second scan line at least one time during the first period, and
wherein the third scan driver supplies a gate-off voltage to the i-th third scan line at least one time during the first period.

18. The display device according to claim 14, wherein the pixel disposed in the i-th pixel row and the j-th pixel column further comprises:
a fifth transistor connected between the first node and the second node, and configured to be turned on in response a third scan signal supplied from an i-th third scan line; and
a sixth transistor connected between the first electrode of the first capacitor and the third node, and configured to be turned on in response to the second scan signal supplied from the i-th second scan line.

19. The display device according to claim 18, wherein a horizontal period in which a data signal is supplied the pixel disposed in the i-th pixel row and the j-t h pixel column includes a first period, a second period, and a third period, and
wherein the display device further comprising:
a data driver configured to supply a voltage of reference power having a voltage value between the first driver power and the second driving power to the j-th data line during the first period and the second period, and supply the data signal to the j-th data line during the third period;
a first scan driver configured to supply the first scan signal to the i-th first scan line during the first to the third periods;
a second scan driver configured to supply the second scan signal to the i-th second scan line during the first period and the second period;
a third scan driver configured to supply the third scan signal to the i-th third scan line during the first period and the second period; and
an emission driver configured to supply the emission control signal to the k-th emission control line during the second period and the third period.

20. The display device according to claim 19, wherein the i-th second sca n line is a scan line identical to the i-th third scan line, and
wherein the second scan driver is a scan driver identical to the third scan driver.
